(19) United States
(12) Patent Application Publication
(10) Pub. No.: US 2020/0139452 A1
(43) Pub. Date: May 7, 2020

(54) Chuck With Detachable Components

(71) Applicant: X'POLE PRECISION TOOLS INC., Taoyuan City (TW)

(72) Inventor: Peter CHEN, Taoyuan City (TW)

(21) Appl. No.: 16/177,795

(22) Filed: Nov. 1, 2018

(51) Int. Cl. B23B 31/20

(52) U.S. Cl. CPC B23B 31/202; B23B 2231/2072

(57) ABSTRACT

A chuck includes a mounting part including a conic connection member and a support member in which an end of the connection member is mounted to a predetermined device, and the support member has an axial channel; and a collet partially disposed in the channel and including an axial slit for receipt a portion of a drill bit, longitudinal first gaps on a surface, each first gap having an open end, and first latches each formed between two adjacent first gaps. In response to a force exerted on the first latches, the first latches are flexibly deformed to clamp the drill bit. The mounting part further includes second latches each formed between two adjacent second gaps.

### BACKGROUND OF THE INVENTION

### 1. Field of the Invention

The invention relates to chucks and more particularly to a chuck with detachable components.

### 2. Description of Related Art

Products having improved precision are widely used in defense industry, aeronautical industry, machines, integrated circuits, automobile industry, etc. In the manufacturing processes, holes less than Φ3.0 mm are drilled into parts. However, drilling a hole of less than Φ3.0 mm has many problems to be solved.

Conventionally, drills, mills, punches, etc. are used for drilling. Also, ultrasonic wave, laser, electrical discharge, electrolysis, etc. are used for drilling.

For machining a workpiece, a chuck is appropriate for fastening a drill bit of greater than Φ3.0 mm. In case of a chuck fastening a drill bit of less than Φ3.0 mm, many disadvantages including the chuck being large, great difficulties in machining, low precision, and increased manufacturing cost exist. To the worse, the drill bit may be broken in operation. All of these are problems to be solved.

The manufacturing cost of a chuck having a hole of less than 13.0 mm for fastening a drill bit is very high. It is known that there are many tools such as mills, drills, lathes, etc. Chucks being employed by them have different shapes and sizes. It is typical that a chuck has a unique collet to cooperate therewith. This further increases the manufacturing cost and complexity.

Thus, the need for improvement still exists.

### SUMMARY OF THE INVENTION

It is therefore one object of the invention to provide a chuck including a collet capable of being fastened in a mounting part which is mounted to a quill of a mill, a drill, a lathe, or the like.

It is another object of the invention to provide a chuck including a collet having advantages of being compact, capable of fastening the drill bit, and having improved precision. It is a further object of the invention to provide a chuck including a collet having advantages of being convenient in operation and capable of greatly decreasing the manufacturing cost.

For achieving above and other objects of the invention, there is provided a chuck comprising a mounting part including a conic connection member and a hollow support member integrally formed with the connection member wherein an end of the connection member is mounted to a predetermined device, and the support member has an axial channel; and a collet partially disposed in the channel and including an axial slit for receipt a portion of a drill bit, a plurality of longitudinal first gaps on a surface, each first gap having an open end, and a plurality of first latches each formed between two adjacent first gaps; wherein in response to a force exerted on the first latches, the first latches are flexibly deformed to clamp the drill bit in the slit.

Preferably, the mounting part further comprises a plurality of longitudinal second gaps each having an open end, and a plurality of second latches each formed between two adjacent second gaps, and wherein in response to a force exerted on the second latches, the second latches are flexibly deformed to clamp the collet in the channel.

Preferably, the collet is configured to secure to one of a plurality of different mounting parts.

### BRIEF DESCRIPTION OF THE DRAWINGS

The invention, as well as its many advantages, may be further understood by the following detailed description and drawings in which:

FIG. 1 is a sectional view of a chuck according to the invention;

FIG. 2 is an exploded view of FIG. 1; and

FIGS. 3, 4, 5 and 6 are sectional views each showing the collet secured to one of four different mounting parts.

### DETAILED DESCRIPTION OF THE INVENTION

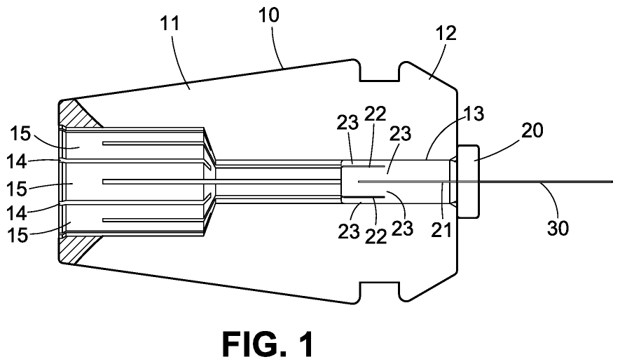

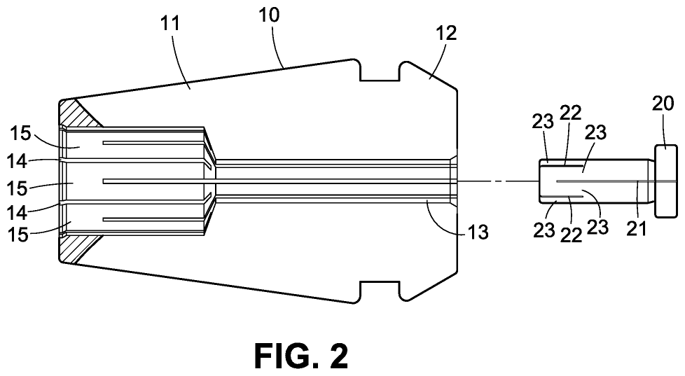

Referring to FIGS. 1 to 3, a chuck in accordance with the invention comprises a mounting part 10 and a collet 20 as discussed in detail below.

The mounting part 10 includes a conic connection member 11 and a hollow support member 12 integrally formed with the connection member 11. An end of the connection member 11 is mounted to quill of a mill, a drill, a lathe, or the like (all not shown). The support member 12 has an axial, stepped-diameter channel 13 with a substantial portion of the collet 20 disposed therein.

The collet 20 include an axial slit 21 for receipt a portion of a drill bit 30, a plurality of longitudinal first gaps 22 on a surface, each first gap 22 having an open end, and a plurality of first latches 23 each formed between two adjacent first gaps 22.

The mounting part 10 further comprises a plurality of longitudinal second gaps 14, each second gap 24 having an open end, and a plurality of second latches 25 each formed between two adjacent second gaps 24.

A fastener (not shown) may be secured to the mounting part 10. For example, the fastener is implemented as a nut which exerts a compressing force on the first latches 15. And in turn, the first latches 15 are flexibly deformed to exert a force to clamp the collet 20. Further, the force exerted on the collet 20 is transmitted to the first latches 23. And in turn, the first latches 23 are flexibly deformed to exert a force to clamp the drill bit 30 in the slit 21.

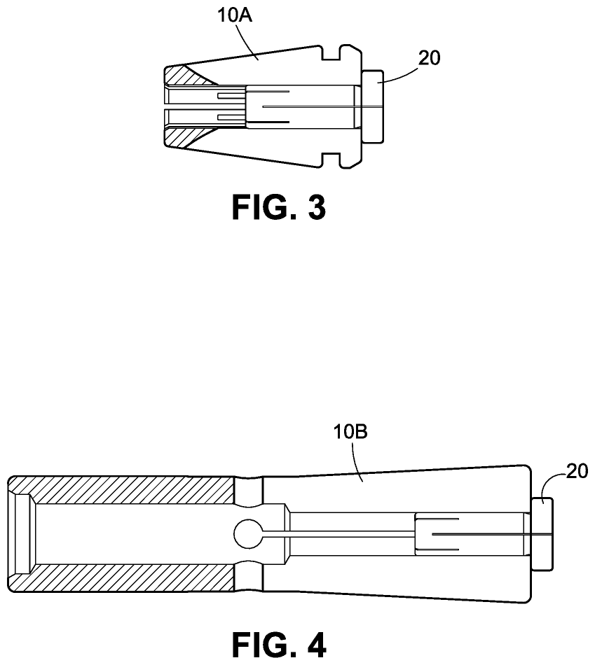

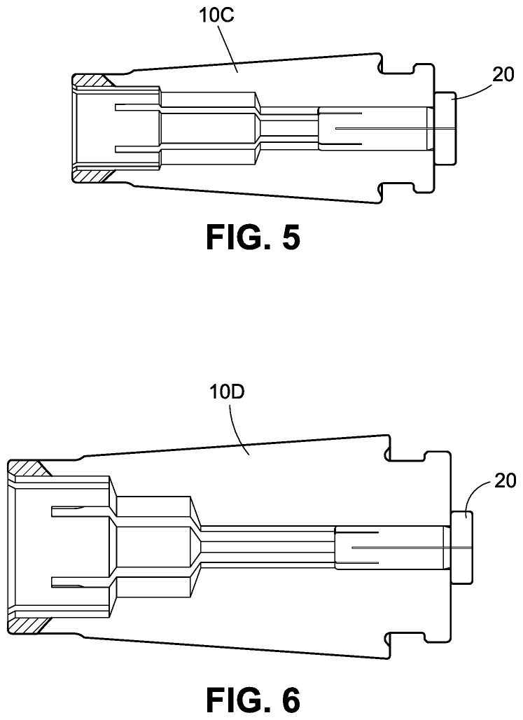

Referring to FIGS. 3 to 6, the collet 20 can be fastened by one of a plurality of different mounting parts such as a mounting part 10A of FIG. 3, a mounting part 10B of FIG. 4, a mounting part 10C of FIG. 5 and a mounting part 10D of FIG. 6. And in turn, each of the mounting parts 10A, 10B, 10C and 10D is mounted to a quill of a mill, a drill, a lathe, or the like (all not shown).

It is envisaged by the invention that the chuck has a collet fastened by a mounting part which is mounted to a quill of a mill, a drill, a lathe, or the like. Further, the collet has advantages of being compact, capable of fastening the drill bit, having improved precision, being convenient in operation, and capable of greatly decreasing the manufacturing cost.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A chuck comprising:
a mounting part including a conic connection member and a hollow support member integrally formed with the connection member wherein an end of the connection member is mounted to a predetermined device, and the support member has an axial channel; and
a collet partially disposed in the channel and including an axial slit for receipt a portion of a drill bit, a plurality of longitudinal first gaps on a surface, each first gap having an open end, and a plurality of first latches each formed between two adjacent first gaps;
wherein in response to a force exerted on the first latches, the first latches are flexibly deformed to clamp the drill bit in the slit.

2. The chuck of claim 1, wherein the mounting part further comprises a plurality of longitudinal second gaps each having an open end, and a plurality of second latches each formed between two adjacent second gaps, and wherein in response to a force exerted on the second latches, the second latches are flexibly deformed to clamp the collet in the channel.

3. The chuck of claim 1, wherein the collet is configured to secure to one of a plurality of different mounting parts.
